(19) United States
(12) Patent Application Publication
(10) Pub. No.: US 2009/0075691 A1
(43) Pub. Date: Mar. 19, 2009

(54) Lighter with cellular phone activating detection device

(76) Inventor: John Jiin Chung Yang, Industry, CA (US)

Correspondence Address: DAVID AND RAYMOND PATENT FIRM, 108 N. YNEZ AVE., SUITE 128, MONTEREY PARK, CA, 91754, US

(21) Appl. No.: 11/901,789

(22) Filed: Sep. 18, 2007

(51) Int. Cl. H04M 1/00

(52) U.S. Cl. 455/556.1

(57) ABSTRACT

A lighter, which is adapted for incorporating with a cellular phone, includes a cellular phone activating detection device supported in a lighter casing. The cellular phone activating detection device includes a power source, a detection circuit unit, and a signal generator electrically coupled with the detection circuit unit. The detection circuit unit, which is electrically linked to the power source, has a detection range in responsive to a hand reachable range of a user for wirelessly detecting an activation of the cellular phone when the cellular phone is located within the detection range with respect to the lighter casing. When the cellular phone is activated, the signal generator generates an attention signal to give the user an attention of the cellular phone.

### BACKGROUND OF THE PRESENT INVENTION

1. Field of Invention

The present invention relates to a lighter, and more particularly to a lighter with cellular phone activating detection device which is supported in a lighter casing of the lighter, wherein the cellular phone activating detection device includes a power source, a detection circuit unit and a signal generator to notify the user that the cellular phone has been activated.

2. Description of Related Arts

In addition to igniting cigarettes and cigars, almost every common household owns at least a couple of lighters for fire lighting convenience. The lighter is small and handy and a smooth thumb strike against the striking wheel or pressing down the igniting button can simply ignite and light-up.

With rapid development of telecommunication and semiconductor fabrication technologies, a cellular phone becomes a popular and convenient tool for mobile communication during these few years. The cellular phone is so common that almost everyone has one nowadays and one who smokes cigarettes or cigars, is more likely to have a lighter and cellular phone with him or her simultaneously.

Generally, when the cellular phone is activated, the user can be notified by the ring tone provided by the cellular phone as the conventional phone. However, in certain circumstances, people will be bothered and annoyed when they hear the ring tone of the cellular phone, such as in a meeting, in class, or in a movie theater. Most cellular phones provide a silent or vibration mode when activated to solve the problem presented above, but the cellular phone vibration will still generate some noise to distract other people in the same room and the user is likely to miss the call when the cellular phone is on its silent mode.

Because the size of the cellular phone becomes smaller and smaller, and the cellular phone has more and more functions, some people may use the cellular phone to tape or transmit the content of conversation in an illegitimate manner. For example, when one is in a meeting, he may hide his cellular phone and call out to someone else, such that the content of the meeting which may be confidential would be transmitted to the person on the other end of the cellular phone, and the confidential information is thus leaked. Under the circumstance, a concealed cellular phone activating detection device is needed so as to allow the person managing the meeting to pause or stop the meeting when the detection device is triggered.

### SUMMARY OF THE PRESENT INVENTION

A main object of the present invention is to provide a lighter with cellular phone activating detection device, wherein the user can switch the cellular phone to a silent mode and when receiving an incoming call, the lighter with the detection device can notify the user of the incoming call without bothering other people and the user is less likely to miss the call even if the cellular phone is in its silent mode.

Another object of the present invention is to provide a lighter with cellular phone activating detection device which has a detection range in responsive to a hand reachable range of the user for wirelessly detecting an activation of the cellular phone when the cellular phone is located within the detection range with respect to the lighter.

Another object of the present invention is to provide a lighter with cellular phone activating detection device, wherein a LED module generates an attention signal when the cellular phone activating detection device is triggered by detecting a communication signal emitted by the cellular phone.

Another object of the present invention is to provide a lighter with cellular phone activating detection device which is adapted for a cellular phone signal indicator when the cellular phone is not allowed in a situation such as a confidential meeting.

In order to achieve the above objects, the present invention provides a lighter equipped with a cellular phone activating detection device which is supported in a lighter casing of the lighter and comprises a power source; a detection circuit unit, which is electrically linked to the power source, having a detection range in responsive to a hand reachable range of a user for wirelessly detecting an activation of the cellular phone when the cellular phone is located within said detection range with respect to the lighter casing; and a signal generator electrically coupled with the detection circuit unit for generating an attention signal when the cellular phone is activated so as to give said user an attention of the cellular phone.

These and other objects, features, and advantages of the present invention will become apparent from the following detailed description, the accompanying drawings, and the appended claims.

### BRIEF DESCRIPTION OF THE DRAWINGS

FIG. 1 is a schematic representation of the present invention when a cellular phone transmits a communication signal to trigger the detection device incorporated with the lighter.

FIG. 2 is an exploded view of the lighter with cellular phone activating detection device of the present invention.

FIG. 3 is a sectional view of the lighter with cellular phone activating detection device of the present invention.

### DETAILED DESCRIPTION OF THE PREFERRED EMBODIMENT

As illustrated above, cellular phone has become one of the most popular and commonly used equipment for mobile communication during these few years. Generally speaking, cellular phone is an electromagnetic wave receiver and transmitter when in use and it continuously receives and transmits signals with the cellular phone base station.

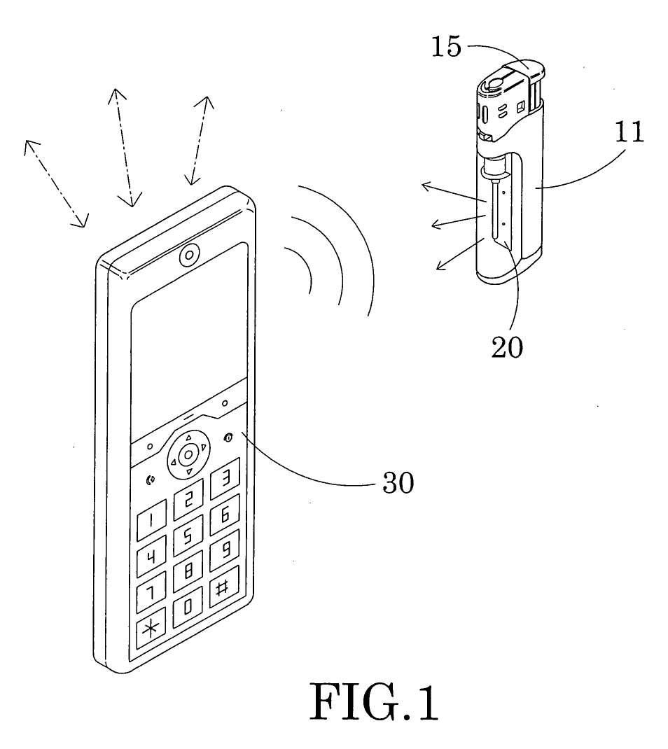

Referring to FIG. 1, a signal is received by the cellular phone 30 from the base station when the user receives a call and a feedback signal is then sent out from the cellular phone 30 to the base station. Also, when the user calls out from the cellular phone 30, the cellular phone 30 transmits a specific signal to the base station to further connect with the call receiver. More specifically, a specific communication signal is emitted from the cellular phone 30 whether the cellular phone 30 receives or makes a call and the specific communication signal, i.e. the activation of the cellular phone 30, can be received by a specific-designed antenna which is able to convert the signal to electric current. In other words, when the antenna is coupled with a signal detection device, the detection device can be triggered by the electric current when the specific signal is received by the antenna.

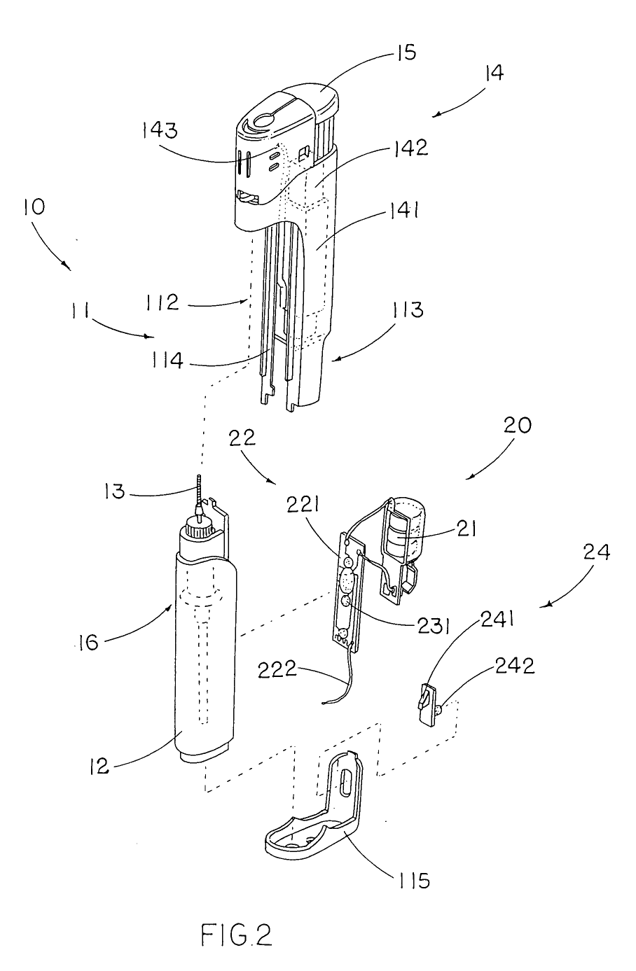

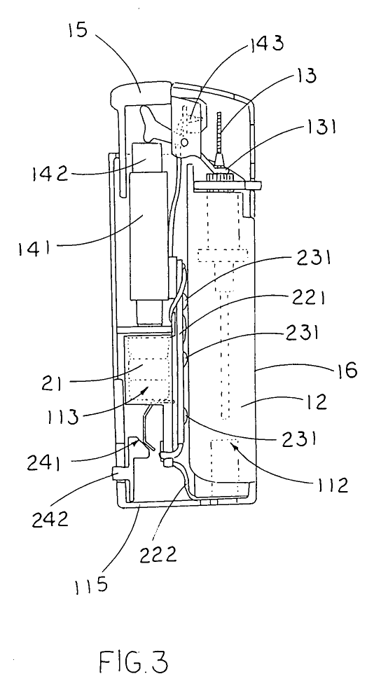

Referring to FIG. 2 and FIG. 3, a lighter 10 incorporating with a cellular phone activating detection device 20 comprises a lighter casing 11 with a liquefied gas storage 12, a gas emitting nozzle 13 appearing at a ceiling of the lighter casing 11 for controlling a flow of gas emitting from the liquefied gas storage 12, a spark generator 14 supported at the lighter casing 11 for generating a spark towards the gas emitting nozzle 13, an ignition button 15 movably supported at the lighter casing 11 to actuate the spark generator 14 and to release the gas from the liquefied gas storage to the gas emitting nozzle 13 so as to ignite the gas thereat.

The spark generator 14 comprises a piezoelectric unit 141 disposed in the lighter casing 11 at a position below the ignition button 15. The piezoelectric unit 141 has an actuation part 142, and a spark generation tip 143 extended close to the gas emitting nozzle 13. When the actuation part 142 is depressed by the ignition button 15, the spark is generated at the spark generating tip 143 towards the gas emitting nozzle 13 to ignite the gas emitted therefrom.

A gas lever 131 is pivotally supported in the lighter casing 11 at a position below the ignition button 15, wherein the gas lever 131 has a lifting end engaging with a valve of the liquefied gas storage 12 and a depressing end arranged in such a manner that when the ignition button 15 is pressed downwardly to depress the depressing end of the gas lever 131, the lifting end of the gas lever 131 is lifted up to open the valve of liquefied gas storage 12 for releasing the gas to the gas emitting nozzle 13. Therefore, when the ignition button 15 is pressed, the spark will be generated towards the gas emitting nozzle 13 to ignite the gas emitting therefrom.

According to the preferred embodiment, the cellular phone activating detection device 20, which is supported in the lighter casing 11, comprises a power source 21, a detection circuit unit 22 electrically linked to the power source 21, a signal generator 23 and an actuation control 24 for selectively controlling the detection circuit unit 22 in an on and off manner.

The detection circuit unit 22 has a detection circuit board 221 supported within the lighter casing 11 at a position adjacent to the liquefied gas storage 12 and an antenna 222 extended from the detection circuit board 221 for wirelessly receiving an activation signal of the cellular phone 30 when the cellular phone 30 is located within the detection range which is defined as a hand reachable range of the user for wirelessly detecting an activation of the cellular phone 30 when the cellular phone 30 is located within the detection range with respect to the lighter casing 11.

The lighter casing 11 has a supporting frame 111 supporting the spark generator 14 thereat and a gas holder 16. The gas holder 16 is made of see-through material, mounted to the supporting frame 111 to define the liquefied gas storage 12 in the gas holder 16 for containing the liquefied gas and to support the gas emitting nozzle 13 at the gas holder 16 for releasing the gas therefrom. The supporting frame 111 also has a side gas compartment 112 for the gas holder 16 detachably mounted thereat and a side power compartment 113 positioned adjacent to the gas compartment 112 to receive the power source 21 of the cellular phone detection device 20 in the power compartment 113.

A compartment wall 114 is formed between the side gas compartment 112 and the power compartment 113, wherein the detection circuit board 221 is securely supported between a side wall of the gas holder 16 and the compartment wall 114 at a position that the LED module 231 illustrated below is facing towards the gas holder 16. In other words, the detection circuit board 221 is protectively supported by the compartment wall 114 and is located at a mid-portion of the lighter casing 11 such that when the lighter of the present invention is dropped accidentally, the detection circuit board 221 will not be broken or damaged by the external force. The lighter casing 11 further comprises an enclosing cap 115 preferably made of metal, attaching to a bottom side of the lighter casing 11 to enclose bottom openings of the side gas compartment 112 and the side power compartment 113. In other words, the lighter will be kept in compact size to support the detection circuit board 221 and the LED module 231 in the lighter casing 11.

A light emitting diode (LED) is commonly used for emitting electroluminescence. It becomes more and more popular to serve as a light-emitting source because it generates various kinds of colors, consumes less power, and is very small in size and easily populated onto printed circuit board. Accordingly, the conventional LED comprises a resin case enclosing a diode therein and two electric terminals extended from the diode through the resin case.

In a preferred embodiment, the signal generator 23 has at least a LED module 231 electrically coupling with the detection circuit unit 22 for generating a light signal as the attention signal. Accordingly, the LED module 231 comprises one or more diodes electrically coupling at the detection circuit board 221. In addition, the diodes of the LED module 231 can generate different color effects and/or different blinking effects to notify the user in responsive to the activation of the cellular phone 30.

More specifically, when the antenna 222 receives the specific communication signal from the cellular phone 30, the antenna 222 can convert the signal to electric current triggering the LED 231 electrically coupling with the detection circuit 22 for generating the light signal so as to give the user an attention of the cellular phone call without generating a ring tone or vibration of the cellular phone. It is worth mentioning that the light signal generated from the LED module 231 penetrates through the see-through gas holder 16 to the exterior of the lighter casing 11.

The antenna 222 has one end electrically coupling with the detection circuit board 221 and an opposed end contacting with the enclosing cap 115 for enhancing a reception of the antenna 222 via the metal made enclosing cap 115. Preferably, the antenna 222 comprises a metal wire adapted to be adjustably bent in different configurations such that the antenna 222 is fitted into the lighter casing 11. It is worth mentioning that the antenna 22 is adapted to extend to any part of the lighter casing 11 made of metal for enhancing the reception. However, the enclosing cap 115 positioned at the bottom of the lighter casing 11 can prevent any piezoelectric shock during ignition operation. In addition, the LED module 231 is supported adjacent to the gas holder 16 for generating the light signal and the user can be notified when seeing through the gas holder 16.

Furthermore, when the signal generator 23 is activated for generating the LED attention signal as in the preferred embodiment, the LED attention signal will last for a predetermined period of time as long as the cellular phone 30 continues to emit the specific communication signal to the base station, such that the user can be notified by the continuous LED attention signal as can be seen in FIG. 1 and FIG. 3. It is worth mentioning that when the cellular phone 30 is turned on and in a normal standby mode, the detection circuit unit 22 will detect no activation signal from the cellular phone 30. Once the user makes a phone call or receives a phone call, the detection circuit unit 22 will detect the activation signal from the cellular phone 30 and activate the signal generator 23.

The actuation control 24 for selectively controlling the detection circuit unit 22 in an on and off manner, wherein the actuation control 24 comprises a contact switch 241 electrically connected between the power source 21 and the detection circuit unit 22, and an actuation switch 242 which is movably supported at an outer side of the lighter casing 11. When the actuation switch 241 is actuated, the contact switch 241 activates the detection circuit unit 22 to form a close circuit thereof and the detection circuit unit 22 is in a status ready to receive the specific communication signal emitted by the cellular phone 30. Accordingly, the actuation switch 242 is slidably mounted at the enclosing cap 115 to actuate the contact switch 241.

Preferably, the user places his or her cellular phone 30 in the hand reachable range along with the lighter 10 incorporating with the cellular phone activating detection device 20. As illustrated above, when the user makes or receives a call, the cellular phone 30 emits the specific communication signal which is received by the antenna 222 electrically coupled with the detection circuit board 221, and the antenna 222 subsequently converts the communication signal to electric current triggering the LED 231 to generating a light signal so as to give the user an attention of the cellular phone call without generating a ring tone or vibration of the cellular phone 30.

This cellular phone-lighter combination can be adapted in various situations such as in a meeting or a movie theater when the cellular phone is should be switch to the silent or vibration mode, wherein the user may miss the call when the cellular phone is in the silent mode and the other people in the meeting may be bothered if the cellular phone is vibrating.

While in a meeting, one may try to transmit the content of the meeting to another outside the meeting by calling a specific person and leaving the cellular phone in a “call-out” status, and thus what people talk in the meeting will be heard by the person on the other end of the cellular phone. In other words, some confidential information may be leaked to others through the cellular phone. As illustrated above, the cellular phone transmits the specific communication signal while receiving or dialing out a call and the cellular phone activating detection device 20 in the present invention can detect this communication signal and convert it to electric current to trigger the LED module 231 as the attention signal. Thus, the detection device 20 in the present invention can be used as a signal indicator such that when one is trying to call out during the meeting, the LED module 231 is then triggered to generate an attention signal and the person managing the meeting can either pause or stop the meeting to prevent some confidential information from leaking.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lighter for incorporating with a cellular phone, comprising:
a lighter casing having a liquefied gas storage;
a gas emitting nozzle appearing at a ceiling of said lighter casing for controlling a flow of gas emitting from said liquefied gas storage;
a spark generator supported at said lighter casing for generating a spark towards said gas emitting nozzle;
an ignition button movably supported at said lighter casing to actuate said spark generator and to release said gas from said liquefied gas storage to said gas emitting nozzle so as to ignite said gas thereat; and
a cellular phone activating detection device, which is supported in said lighter casing, comprising:
a power source;
a detection circuit unit, which is electrically linked to said power source, having a detection range in responsive to a hand reachable range of a user for wirelessly detecting an activation of said cellular phone when said cellular phone is located within said detection range with respect to said lighter casing; and
a signal generator electrically coupled with said detection circuit unit for generating an attention signal when said cellular phone is activated so as to give said user an attention of said cellular phone.

2. The lighter, as recited in claim 1, wherein said detection circuit unit comprises a detection circuit board supported within said lighter casing at a position adjacent to said liquefied gas storage and an antenna extended from said detection circuit board for wirelessly receiving an activation signal of said cellular phone when said cellular phone is located within said detection range.

3. The lighter, as recited in claim 2, wherein said signal generator comprises at least a LED module electrically coupling with said detection circuit for generating a light signal as said attention signal.

4. The lighter, as recited in claim 1, wherein said cellular phone activating detection device further comprises an actuation control for selectively controlling said detection circuit unit in an on and off manner, wherein said actuation control comprises a contact switch electrically connected between said power source and said detection circuit unit, and an actuation switch which is movably supported at an outer side of said lighter casing and is arranged in such a manner that when said actuation switch is actuated, said contact switch activates said detection circuit unit to form a closed circuit thereof so as to switch on said detection circuit unit for detection of said activation of said cellular phone.

5. The lighter, as recited in claim 3, wherein said cellular phone activating detection device further comprises an actuation control for selectively controlling said detection circuit unit in an on and off manner, wherein said actuation control comprises a contact switch electrically connected between said power source and said detection circuit unit, and an actuation switch which is movably supported at an outer side of said lighter casing and is arranged in such a manner that when said actuation switch is actuated, said contact switch activates said detection circuit unit to form a closed circuit thereof so as to switch on said detection circuit unit for detection of said activation of said cellular phone.

6. The lighter, as recited in claim 4, wherein said signal generator is activated for generating said attention signal for a predetermined time period when said actuation switch is actuated to switch on said detection circuit unit to notify a status of said detection circuit unit.

7. The lighter, as recited in claim 5, wherein said signal generator is activated for generating said attention signal for a predetermined time period when said actuation switch is actuated to switch on said detection circuit unit to notify a status of said detection circuit unit.

8. The lighter, as recited in claim 3, wherein said lighter casing comprises a supporting frame supporting said spark generator thereat and a gas holder, which is made of see-though material, mounted to said supporting frame to define said liquefied gas storage in said gas holder for containing said liquefied gas and to support said gas emitting valve supported at said gas holder for releasing said gas from said gas holder, wherein said LED module is supported adjacent to said gas holder for generating said light signal through said gas holder.

9. The lighter, as recited in claim 5, wherein said lighter casing comprises a supporting frame supporting said spark generator thereat and a gas holder, which is made of see-though material, mounted to said supporting frame to define said liquefied gas storage in said gas holder for containing said liquefied gas and to support said gas emitting valve supported at said gas holder for releasing said gas from said gas holder, wherein said LED module is supported adjacent to said gas holder for generating said light signal through said gas holder.

10. The lighter, as recited in claim 7, wherein said lighter casing comprises a supporting frame supporting said spark generator thereat and a gas holder, which is made of see-though material, mounted to said supporting frame to define said liquefied gas in said gas holder for containing said liquefied gas and to support said gas emitting valve supported at said gas holder for releasing said gas from said gas holder, wherein said LED module is supported adjacent to said gas holder for generating said light signal through said gas holder.

11. The lighter, as recited in claim 8, wherein said supporting frame has a side gas compartment for said gas holder detachably mounted thereat and a side power compartment positioned adjacent to said gas compartment to receive said power source of said cellular phone activating detection device in said power compartment.

12. The lighter, as recited in claim 9, wherein said supporting frame has a side gas compartment for said gas holder detachably mounted thereat and a side power compartment positioned adjacent to said gas compartment to receive said power source of said cellular phone activating detection device in said power compartment.

13. The lighter, as recited in claim 10, wherein said supporting frame has a side gas compartment for said gas holder detachably mounted thereat and a side power compartment positioned adjacent to said gas compartment to receive said power source of said cellular phone activating detection device in said power compartment.

14. The lighter, as recited in claim 10, wherein said supporting frame further has a compartment wall formed between said side gas compartment and said side power compartment, wherein said detection circuit board is securely supported between a side wall of said gas holder and said compartment wall at a position that said LED module is facing towards said gas holder.

15. The lighter, as recited in claim 13, wherein said supporting frame further has a compartment wall formed between said side gas compartment and said side power compartment, wherein said detection circuit board is securely supported between a side wall of said gas holder and said compartment wall at a position that said LED module is facing towards said gas holder.

16. The lighter, as recited in claim 13, wherein said lighter casing further comprises an enclosing cap, which is made of metal, attaching to a bottom side of said lighter casing to enclose bottom openings of said side gas compartment and said side power compartment, wherein said antenna has one end electrically coupling with said detection circuit board and an opposed end contacting with said enclosing cap for enhancing an reception of said antenna via said enclosing cap.

17. The lighter, as recited in claim 15, wherein said lighter casing further comprises an enclosing cap, which is made of metal, attaching to a bottom side of said lighter casing to enclose bottom openings of said side gas compartment and said side power compartment, wherein said antenna has one end electrically coupling with said detection circuit board and an opposed end contacting with said enclosing cap for enhancing an reception of said antenna via said enclosing cap.

18. The lighter, as recited in claim 1, wherein said spark generator comprises a piezoelectric unit, which is disposed in said lighter casing at a position below said ignition button, having an actuation part and a spark generating tip which is extended close to said gas emitting nozzle and is arranged in such a manner that when said actuation part is depressed by said ignition button, said spark is generated at said spark generating tip towards said gas emitting nozzle.

19. The lighter, as recited in claim 10, wherein said spark generator comprises a piezoelectric unit, which is disposed in said lighter casing at a position below said ignition button, having an actuation part and a spark generating tip which is extended close to said gas emitting nozzle and is arranged in such a manner that when said actuation part is depressed by said ignition button, said spark is generated at said spark generating tip towards said gas emitting nozzle.

20. The lighter, as recited in claim 17, wherein said spark generator comprises a piezoelectric unit, which is disposed in said lighter casing at a position below said ignition button, having an actuation part and a spark generating tip which is extended close to said gas emitting nozzle and is arranged in such a manner that when said actuation part is depressed by said ignition button, said spark is generated at said spark generating tip towards said gas emitting nozzle.
